(19) United States
(12) Patent Application Publication
(10) Pub. No.: US 2008/0313032 A1
(43) Pub. Date: Dec. 18, 2008

(54) METHOD FOR OPERATING A POINTS INCENTIVE PROGRAM

(76) Inventor: Gino Fiorucci, Brampton (CA)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 11/762,926

(22) Filed: Jun. 14, 2007

(51) Int. Cl. G06Q 30/00

(52) U.S. Cl. 705/14

(57) ABSTRACT

The present invention is a method for operating a points incentive program comprising three steps. The first step is to provide consolidation of third party account information into a single source identifier. The second step is to allocate points received by the source identifier to each respective third party account in their due proportion. The final step is to distribute those points received by the source identifier to each respective third party account, in their due proportion. This method allows users to participate in multiple reward or incentive programs without carrying with them, multiple individual source identifiers connected to each of said reward or incentive programs.

### FIELD OF THE INVENTION

The present invention is a method for operating a points incentive program, and more specifically a method providing for the consolidation of third party programs, and allocation and distribution of points thereto.

### BACKGROUND OF THE INVENTION

In modern commerce, numerous points-based incentive or rewards programs are known (AIR MILES™, HBC REWARDS™, AEROPLAN™ just to name a few). These different branded programs operate in a similar or identical fashion, as described below.

A third party issues account information to a user, that account information usually being encoded on a proprietary source identifier like a plastic card (or other media such as magnetic tags, sticks, and the like). The user, in making a purchase related or connected to the reward program, presents his account information (via the card or other device) to a retailer, and is assigned a predetermined number of points based on his purchase or activity. These assigned points are sent by the retailer to the third party and ultimately credited to the user's account. When the user has earned enough points, he is entitled to redeem those points through the third party, for some type of reward like airfare, merchandise, entertainment venues, etc.

Because third parties typically issue plastic cards or other bulky source identifiers to the user as a device for collecting the points, the user is, if a member of multiple reward programs, forced to carry multiple cards or devices. The carrying of multiple devices by the user is bulky, cumbersome, sometimes results in a low rate of participation in reward programs, and is generally unwanted.

### SUMMARY OF THE INVENTION

The present invention is a method for operating a points incentive program comprising three steps. The first step is to provide consolidation of third party account information into a single source identifier. The second step is to allocate points received by the source identifier to each respective third party account in their due proportion. The final step is to distribute those points received by the source identifier to each respective third party account, in their due proportion.

### DESCRIPTION OF THE DRAWINGS

FIG. 1 is a flow chart of a method for operating a points incentive program.

FIG. 2 is a flow chart of an alternate method for operating a points incentive program.

### DETAILED DESCRIPTION OF THE DRAWINGS

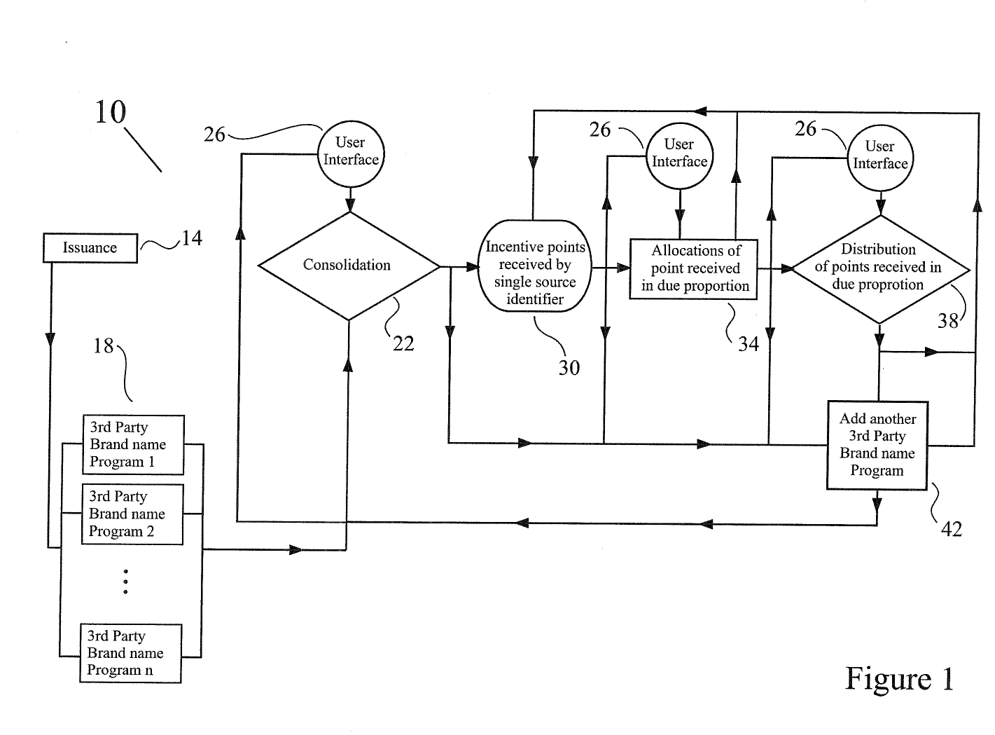

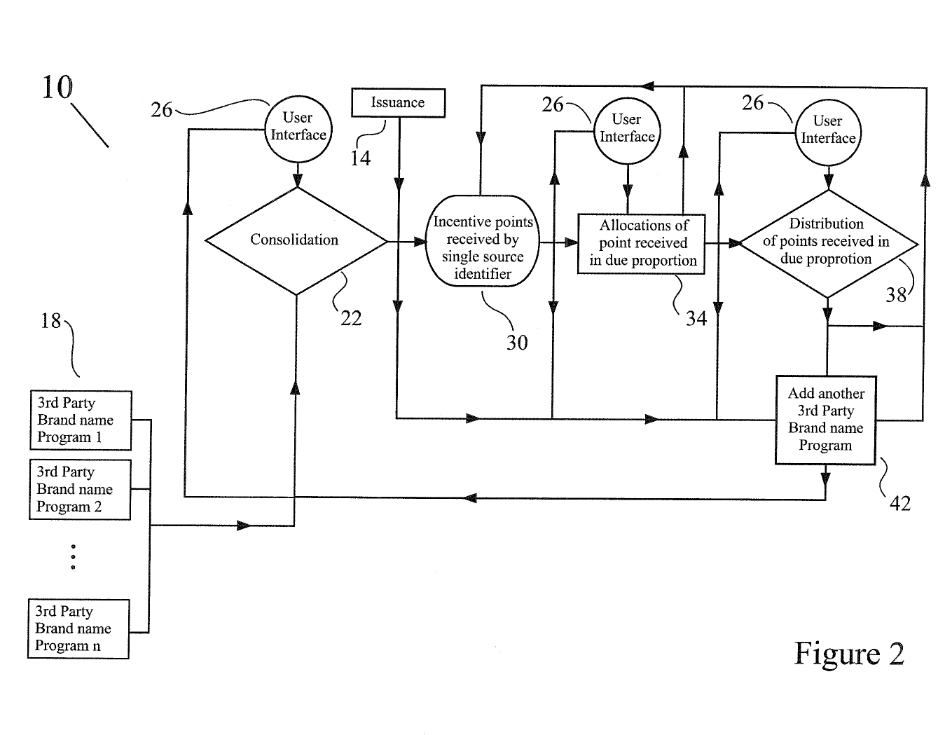

FIG. 1 reference numeral 10 refers generally to a method for operating a points incentive or reward program. In operating the program 10, a single source identifier is issued to a user 14. This identifier is issued by either the practitioner of this method, or any other party acting in direct or indirect support of the practitioner, to a user, and the issuance of the identifier can occur before (FIG. 1) or after (FIG. 2) consolidation (as described below) is performed. An identifier is any media capable of storing or recording account information (for example an encoded key tag or magnetic stick), and additionally can be at least any one of a group comprising a global computer network interface (e.g. a Web site), a telephone, and a personal digital assistant.

The identifier is encoded with or connected to third party account information varying in number and specifics, according to the criteria of the third party and as directed by a user 18. Moreover the identifier can be encoded with or connected to multiple third party account information thereby consolidating said information 22 into the single source identifier (in FIGS. 1 and 2 “n” is a positive integer), providing a single access point for the user. Additional third party information can be added any time 42 subsequent to the initial issuance of the single source identifier 14, and the issuance 14 step normally occurs only once in the entire method. For example, where the identifier is a plastic card with a magnetic strip, the magnetic strip is encoded to identify the user. That user identity is in turn connected to the desired third party account information (through consolidation 22) as directed by the user 18, 42.

The consolidation 22 can be performed by the user and can be accomplished through any appropriate user interface 26 such as a telephone, global computer network interface (e.g. a Web site), a personal digital assistant, or the like.

When the user employs the identifier in a transaction, proprietary third party reward or incentive points are credited to the identifier 30. Subsequent to the single source identifier being issued 14 to the user, the user can collect third party reward or incentive points 30 at any time otherwise during the execution of this method 10.

The points received by the identifier are then allocated in their due proportion to the relevant third party or parties 34, based on codification attached to the points. For example, if a user employs the identifier at one retailer offering thirty AIR MILES™ points, at a second offering forty-two AEROPLAN™ points, and at a third offering eighteen AIR MILES™ points, these points are then appropriately identified (through attached codification) and proportionately allocated (thirty plus eighteen points allocated to AIR MILES™ (or forty-eight points in total); forty-two points allocated to AEROPLAN™). Once allocated these points are distributed in their due proportion to the appropriate third party accounts 38 for redemption through the respective third party proprietors.

Just as with the consolidation, each of the allocation 34 and distribution 38 can be manually performed and managed by the user, and can be accomplished through any appropriate user interface 26 such as a telephone, global computer network interface (e.g. a Web site), a personal digital assistant, or the like.

What is claimed is:

1. A method for operating a points incentive program comprising:
(a) providing consolidation of third party account information into a single source identifier;
(b) providing allocation of points received by the source identifier to each respective third party account in due proportion; and
(c) providing distribution of points received by the source identifier to each respective third party account in due proportion.

2. The program as claimed in claim 1 wherein the consolidation is provided through a user interface.

3. The program as claimed in claim 2 wherein the interface is accessed through one of a group comprising a global computer network, a telephone, and a personal digital assistant.

4. The program as claimed in claim 1 wherein the allocation is provided through a user interface.

5. The program as claimed in claim 4 wherein the interface is accessed through one of a group comprising a global computer network, a telephone, and a personal digital assistant.

6. The program as claimed in claim 1 wherein the distribution is provided through a user interface.

7. The program as claimed in claim 6 wherein the interface is accessed through one of a group comprising a global computer network, a telephone, and a personal digital assistant.

8. A method for operating a points incentive program comprising:
(a) providing consolidation of third party account information into a single source identifier:
(b) issuing the single source identifier to a user;
(c) providing allocation of points received by the source identifier to each respective third party account in due proportion; and
(d) providing distribution of points received by the source identifier to each respective third party account in due proportion.

9. A method for operating a points incentive program comprising:
(a) issuing a single source identifier to a user;
(b) providing consolidation of third party account information into the single source identifier;
(c) providing allocation of points received by the source identifier to each respective third party account in due proportion; and
(d) providing distribution of points received by the source identifier to each respective third party account in due proportion.

10. The program as claimed in claim 1 wherein the single source identifier is one of a group comprising a global computer network interface, a telephone, a personal digital assistant, and a magnetic tag.

11. The program as claimed in claim 8 wherein the single source identifier is one of a group comprising a global computer network interface, a telephone, a personal digital assistant, and a magnetic tag.

12. The program as claimed in claim 9 wherein the single source identifier is one of a group comprising a global computer network interface, a telephone, a personal digital assistant, and a magnetic tag.
